(19) United States
(12) Patent Application Publication
(10) Pub. No.: US 2026/0316938 A1
(43) Pub. Date: Oct. 15, 2026

(54) AIRCRAFT SEAT AND AIRCRAFT

(71) Applicants: AIRBUS (BEIJING) ENGINEERING CENTRE COMPANY LIMITED, Beijing (CN); AIRBUS (CHINA) ENTERPRISE MANAGEMENT AND SERVICES COMPANY LIMITED, Beijing (CN); AIRBUS (S.A.S.), Blagnac (FR); AIRBUS OPERATIONS GmbH, Hamburg (DE)

(72) Inventors: Cedric VALETTE, Blagnac (FR); Andreas MAURMAIER, Beijing (CN); Alejandro MORALES ANTON, Beijing (CN); Changming CHEN, Beijing (CN); Clement BUFFLE, Blagnac (FR); Paul EDWARDS, Hamburg (DE); Liyun CAO, Beijing (CN); Jie YU, Beijing (CN)

(21) Appl. No.: 19/120,041

(22) PCT Filed: Oct. 9, 2023
(86) PCT No.: PCT/CN2023/123496

§ 371 Date: Apr. 10, 2025

(30) Foreign Application Priority Data
Oct. 11, 2022 (CN) 202211239192.2

(51) Int. Cl. B64D 11/06; B64C 1/10; B64D 11/00

(52) U.S. Cl. CPC B64D 11/064; B64C 1/10; B64D 11/00153; B64D 11/0644; B64D 11/0691

(57) ABSTRACT

An aircraft seat is disclosed including a headrest; a backrest; and a seat plate pivotably mounted to the backrest and configured to be pivotable relative to the backrest from a seat plate stowed position to a seat plate expanded position for seating by a user and to be automatically pivotable from the seat plate expanded position to the seat plate stowed position in response to the user's departure. The aircraft seat is further provided with a display configured to displace as the seat plate pivots. The aircraft includes the above aircraft seat. The aircraft seat and the aircraft can facilitate the cabin crew to observe the situation in the cabin compartment when sitting on the aircraft seat, and ensure the utilization rate of the compartment space.

This application claims the benefit of priority to the following Chinese patent application: Chinese patent application No. 202211239192.2, titled “AIRCRAFT SEAT AND AIRCRAFT”, filed with the China National Intellectual Property Administration on Oct. 11, 2022. Above Chinese patent application is incorporated herein by reference in their entirety.

### FIELD

The present disclosure relates to the field of aircraft. More specifically, the present disclosure relates to an aircraft seat and an aircraft having the same.

### BACKGROUND

The contents of this section only provide background information related to this disclosure, which may not constitute the prior art.

Space onboard an aircraft is generally limited and some areas of an aircraft passenger or cockpit compartment require particular attention to combined safety and space constraints, especially in areas of the aircraft where seats are arranged in proximity to any aircraft emergency egress or exit door, or where the aircraft crew (cabin crew, loadmasters, cockpit crew, etc.) are principally are located during operation of the aircraft.

Seats located in certain emergency areas in proximity to emergency exit doors and main compartment doors are typically designed to have one or more components of the seat that can manually or automatically assume a stowed position when the user is not occupying the seat. Examples include seat pads/plates and tray tables. This is necessary in order to reduce the space envelope occupied by the seat so as to avoid obstructing a passenger or crew member trying to move around or past the seat during rapid egress of the aircraft compartment.

Placement of seats or equipment in these areas or the design of the seats themselves must ensure that the crew's visual demarcation field (also known as a field of view) is also not obstructed. The crew are required to have a demarcation field of at least 50% of the cabin compartment area while the aircraft is in flight. This requirement increases to at least 80% of the entire compartment by means of rotation of head and body within 15°. This visual demarcation field ensures that the conditions of the compartment can be easily observed by the crew, who must constantly observe the condition of the occupants and equipment to ensure the safety and security, especially during the take-off and landing of the aircraft. Taking into consideration these field of view requirements, the aircraft designer often may need to avoid arranging seats at certain locations due to limitation of visibility, which makes it impossible to use the space in the compartment of the aircraft with maximum efficiency.

Therefore, it is desirable to improve the design of the aircraft seats to facilitate higher seat numbers in the cabin and/or more efficient seating arrangements in the aircraft, whilst also ensuring a design that is compliant with emergency egress and crew field of view requirements.

### SUMMARY

An object of the present disclosure is to provide an aircraft seat that occupies smaller space envelope when unocuppied compared to when it is occupied, and when arranged in proximity to an aircraft emergency exit area. A further object is to provide an improved design of an aircraft seat for use by crew, so that a crew member seated on the aircraft seat can easily observe the situation in the main cabin compartment without giving up the use of a part of the space in the compartment that otherwise can be used for installing seats.

An aircraft seat is provided, where the aircraft seat includes: a headrest; a backrest located below the headrest; and a seat plate pivotably mounted to the backrest and configured to be pivotable relative to the backrest from a seat plate stowed position to a seat plate expanded position for seating by a user and to be automatically pivotable from the seat plate expanded position to the seat plate stowed position in response to the user's departure. The aircraft seat is further provided with a display which may be configured to receive and display footage of a passenger cabin of the aircraft, or other footage, and to displace as the seat plate pivots. When the seat plate is pivoted to the seat plate expanded position, the display is displaced to a display standby position, and as the seat plate pivots to the seat plate stowed position, the display is displaced to a display stowed position.

The display may be mounted to a first end of a support rod, and the support rod is configured to pivot following pivoting of the seat plate.

The display may be mounted to the support rod via a connecting device, where the connecting device may include: a first connecting member pivotably mounted to the first end of the support rod; and a second connecting member, where the display is mounted to a first end of the second connecting member, and a second end of the second connecting member is pivotably mounted to the first connecting member. One of the first connecting member and the second connecting member may be configured to pivot about a pivot axis transverse to the support rod to adjust a pitch angle of the display, and the other of the first connecting member and the second connecting member may be configured to pivot about a pivot axis parallel to the support rod to adjust a roll angle of the display.

A second end of the support rod may be mounted to a front end portion of the seat plate or to a pivot shaft of the seat plate, and the support rod may be configured to be pivotable relative to the seat plate.

A second end of the support rod may be pivotably mounted to a side portion of the backrest. Alternatively, the second end of the support rod may be pivotably mounted to a bulkhead on which the aircraft seat is mounted, and may be mounted close to a side portion of the backrest.

The aircraft seat may further include a linkage mechanism configured to correspondingly pivot the pivot shaft of the support rod in accordance with the pivoting of the pivot shaft of the seat plate.

The linkage mechanism may include a sensor and an electric motor, where the sensor may be configured to detect the pivoting of the pivot shaft of the seat plate, and the electric motor may be configured to drive the pivot shaft of the support rod to pivot according to the detection result of the sensor.

The display stowed position may be one of the following positions: above the headrest; below the seat plate; or in the headrest.

The aircraft seat may further include an armrest, where the armrest may be configured to pivot following pivoting of the seat plate, the display may be supported by the armrest, and the display may be foldable, capable of being wound or otherwise retracted such that the display may be received in the armrest.

Preferably, the display screen of the display is embodied as a flexible type of display screen, meaning it may be reversibly deformed. As flexible OLED screen is one example of such a display screen.

An aircraft is also provided that includes the aircraft seat according to any of the above mentioned summary.

The aircraft seat may be mounted to a bulkhead within the cabin compartment of the aircraft, and the bulkhead may be further mounted with an additional display located above the headrest of the aircraft seat.

The cabin compartment may be a passenger compartment or a cockpit of the aircraft.

The aircraft seat and the aircraft according to the present disclosure can be compliant with requirements on emergency egress and crew field of view, facilitate the crew to observe the situation in the cabin compartment when sitting on the aircraft seat, so that the crew does not need to stand up or walk around the cabin compartment to observe the situation in the compartment, and further, there is no need to give up the use of a part of the available space for seats in the cabin compartment to meet the field of view requirements of the crew, thereby ensuring that the utilization rate of the cabin space is improved, and facilitating higher density or more efficient seating arrangements in the aircraft.

Features and other advantages of the present disclosure will become apparent from the following non-limiting detailed description.

### BRIEF DESCRIPTION OF THE DRAWINGS

The embodiments of the present disclosure will be described below with reference to the drawings only by way of example. In the drawings, same features or components are indicated by same reference numerals, and the drawings may not be drawn to scale. In the drawings:

FIG. 1 shows a view of an aircraft seat according to a first embodiment of the present disclosure;

FIGS. 2 to 5 show an example of a connecting device between a display and a support rod of the aircraft seat according to the first embodiment of the present disclosure;

FIG. 6 shows a modified example of the connecting device between the display and the support rod of the aircraft seat according to the first embodiment of the present disclosure;

FIG. 7 shows a view of an aircraft seat according to a second embodiment of the present disclosure;

FIGS. 8 to 11 show schematic views of an aircraft seat according to a third embodiment of the present disclosure;

FIG. 12 shows a schematic view of a linkage mechanism of the aircraft seat according to the third embodiment of the present disclosure;

FIG. 13 shows a modified example of the linkage mechanism of the aircraft seat according to the third embodiment of the present disclosure;

FIGS. 14 to 17 show schematic views of an aircraft seat according to a fourth embodiment of the present disclosure;

FIG. 18 show a schematic view of an aircraft seat according to a fifth embodiment of the present disclosure;

FIG. 19 show a schematic view of an aircraft seat according to a sixth embodiment of the present disclosure;

FIGS. 20 to 22 show schematic views of an armrest of the aircraft seat according to the sixth embodiment of the present disclosure;

FIG. 23 shows a modified example of the armrest of the aircraft seat according to the sixth embodiment of the present disclosure;

FIG. 24 shows another modified example of the armrest of the aircraft seat according to the sixth embodiment of the present disclosure;

FIG. 25 show a schematic view of an aircraft seat according to a seventh embodiment of the present disclosure; and

FIG. 26 shows a perspective view of an aircraft installed with the aircraft seat according to the present disclosure.

### DETAILED DESCRIPTION OF THE EMBODIMENTS

The following description is essentially only illustrative, rather than intended to limit the present disclosure and the application or usage thereof. It should be appreciated that, throughout all drawings, similar reference signs indicate the same or similar parts or features. Each drawing only illustratively shows the concept and principle of the embodiments of the present disclosure, and does not necessarily show the specific dimensions and scales of various embodiments of the present disclosure. Specific parts in specific drawings may be exaggerated to illustrate related details or structures of various embodiments of the present disclosure.

In the description of the embodiments of the present disclosure, the orientation terms related to “upper”, “lower”, “left”, and “right” used herein are described according to the upper, lower, left and right position relationships of the views shown in the accompanying drawings. Besides, the terms used herein in relation to “front end portion” and “rear end portion” are described with the direction the user is facing as shown in the drawings as a reference, an end portion on the front side relative to the direction the user is facing is defined as the “front end portion”, while another end portion located on the rear side is defined as the “rear end portion”. In practical applications, the positional relationships of “upper”, “lower”, “left”, and “right” used herein may be defined according to actual conditions. These relationships may be reversed. In addition, unless otherwise explicitly expressed in the present disclosure, the conjunction word “or” includes the meaning of “and/or”.

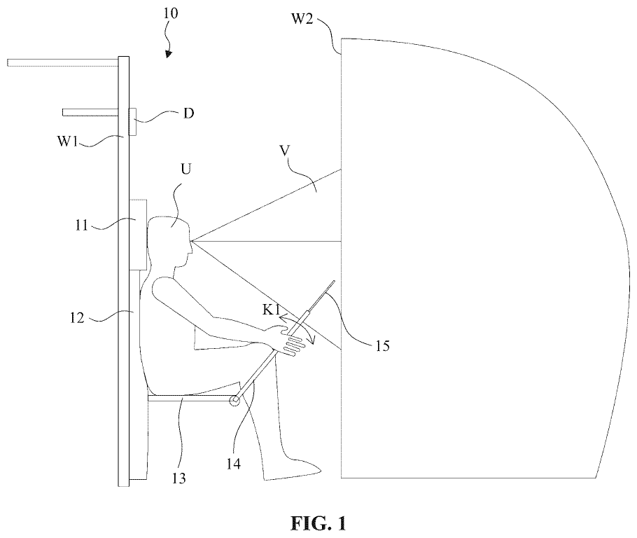

The aircraft seat according to the present disclosure is introduced in conjunction with the application of the aircraft seat in a flight attendant seat in a passenger cabin in an aircraft. FIG. 1 shows a view of an aircraft seat 10 according to a first embodiment of the present disclosure, where a flight attendant U is seated on the aircraft seat 10.

As shown in FIG. 1, the aircraft seat 10 is arranged at an aisle close to a cabin door in a passenger cabin of the aircraft, and is arranged between the bulkheads W1 and W2 opposite each other, so as not to hinder as much as possible the movement of passengers in the passenger cabin. The bulkheads W1 and W2 may be, for example, the outer wall plates of a compartment such as an on-board washing room or a pantry.

The aircraft seat 10 includes a headrest 11, a backrest 12, and a seat plate 13. The headrest 11 and the backrest 12 are fixedly mounted to the bulkhead W1. The seat plate 13 is in the form of an automatically rebound seat plate and is pivotably mounted to the backrest 12. Specifically, a rear end portion of the seat plate 13 is pivotably mounted to the backrest 12. The seat plate 13 can be pivoted relative to the backrest 12 to a seat plate expanded position for seating by an user (for example, the flight attendant U) in response to a force from the user, as shown in FIG. 1; and can automatically pivot toward the backrest 12 to the seat plate stowed position in response to the departure of the flight attendant U from the seat plate 13. In the seat plate stowed position, the seat plate 13 is folded on the backrest 12, thereby reducing the space occupied by the seat plate 13. Preferably, an automatically rebound connecting device between the seat plate 13 and the backrest 12 is in the form of a damping connecting device, so that when the seat plate 13 is about to pivot to the seat plate stowed position, the pivoting of the seat plate 13 towards the backrest 12 can be slowed down, thereby avoiding a large impact. The damping connecting device may adopt any suitable type of damping connecting device. For example, the damping connecting device may be similar to the damping hinge connecting device installed between the cabinet and the door of furniture.

Besides, as shown in FIG. 1, the aircraft seat 10 is further provided with a display 15. The display 15 can receive the information of a camera (not shown in the figure) used to monitor the footage in the passenger cabin, and display the footage captured by the camera on the display screen of the display 15. Further, the display 15 is configured to displace as the seat plate 13 pivots, so that the flight attendant U can easily observe the state of the passengers in the passenger cabin when sitting on the aircraft seat 10, and the flight attendant does not need to walk around the passenger cabin to confirm the state of the passengers, and further, there is no need to give up the use of a part of the available space for passenger seats in the passenger cabin to meet the view requirements of the flight attendant. The display 15 is mounted to the seat plate 13 via a support rod 14. The support rod 14 is configured to pivot following pivoting of the seat plate 13, thereby enabling the display 15 to be displaced as the seat plate 13 pivots.

In the example shown in the figure, the display 15 is mounted to a first end of the support rod 14, and an opposite second end of the support rod 14 is pivotably mounted to a front end portion of the seat plate 13, so that the support rod 14 can pivot together with the seat plate 13, and the support rod 14 can also pivot relative to the seat plate 13. The pivotable connection between the support rod 14 and the seat plate 13 can be achieved by a pivotal connecting mechanism with a self-locking function, so that the support rod 14 can be pivoted relative to the seat plate 13 and locked at any angular position. The pivotal connecting mechanism with the self-locking function may adopt any suitable self-locking pivotal connecting mechanism. For example, the self-locking pivotal connecting mechanism used herein may be similar to the self-locking pivotal connecting mechanism used in laptops for adjusting and locking the angle between the display screen and the body of the laptop, or it may be a self-locking gas spring.

When the flight attendant U is seated on the seat plate 13 of the aircraft seat 10, as the seat plate 13 is pivoted to the seat plate expanded position, the display 15 is displaced to a display standby position in front of the flight attendant U, as shown in FIG. 1, and the display 15 in the display standby position is located in the view field V of the flight attendant U, so that the flight attendant U can observe the passenger seats and passengers seated on the passenger seats in the passenger cabin through the footage of the passenger cabin displayed on the display 15. Further, the flight attendant U can also pivot the support rod 14 relative to the seat plate 13 by applying force to the support rod 14 as required, as indicated by the double-headed arrow K1 in FIG. 1, so as to adjust the display 15 at the first end of the support rod 14 to a suitable position within the view field V of the flight attendant U. When the flight attendant U gets up from the seat plate 13, the seat plate 13 automatically pivots to the seat plate stowed position, and the support rod 14 also automatically pivots following the pivoting of the seat plate 13 toward the bulkhead W1, so as to displace the display 15 to the display stowed position above the headrest 11 of the aircraft seat 10 without additional operation by the flight attendant U.

Preferably, the display 15 is pivotable relative to the support rod 14 to adjust the angle of the display screen of the display 15.

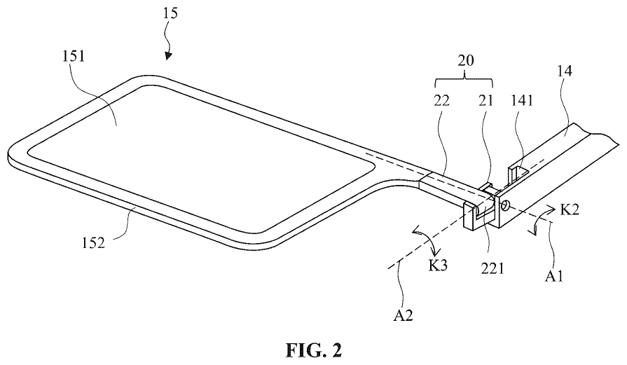

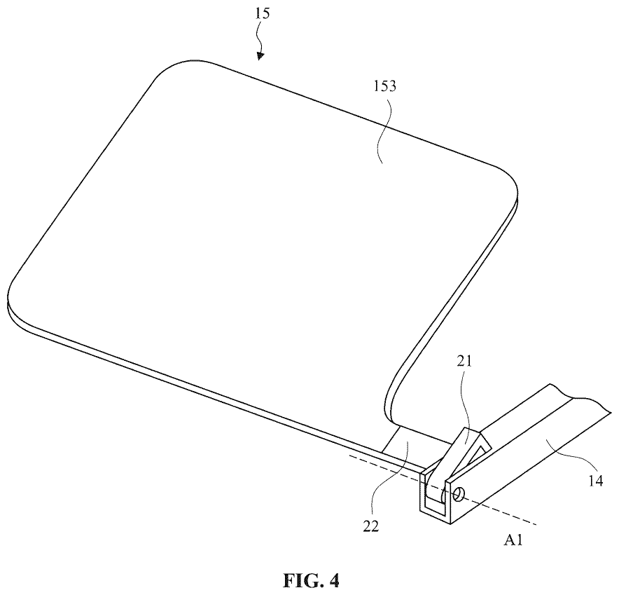

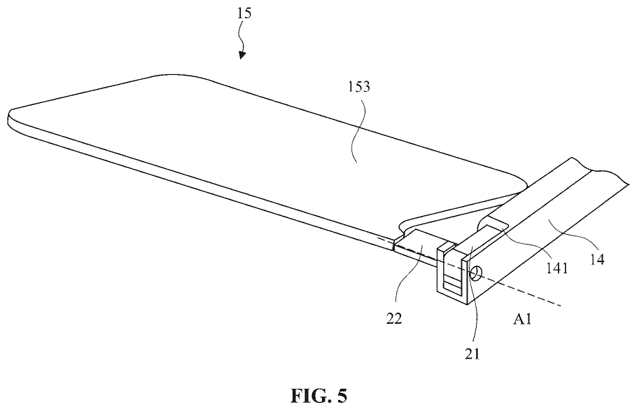

FIGS. 2 to 5 show an example of a connecting device between the display 15 and the support rod 14. As shown in FIG. 2, the connecting device 20 between the display 15 and the support rod 14 includes a first connecting member 21 and a second connecting member 22. The first connecting member 21 is pivotably mounted to a first end of the support rod 14. The display 15 is mounted to a first end of the second connecting member 22, and an opposite second end of the second connecting member 22 is pivotably mounted to the first connecting member 21. In this example, the first connecting member 21 is pivotable relative to the support rod 14 about a pivot axis Al transverse to the support rod 14, as indicated by the double-headed arrow K2 in FIG. 2, to adjust a pitch angle of the display 15. For example, as shown in FIG. 2, the first connecting member 21 can pivot about the pivot axis Al from a recess 141 at an end portion of the support rod 14 to the outside, or, as shown in FIG. 5, the first connecting member 21 can pivot about the pivot axis A1 into the recess 141. The second connecting member 22 is pivotable relative to the first connecting member 21 about a pivot axis A2 parallel to the support rod 14, as indicated by the double-headed arrow K3 in FIG. 2, to adjust a roll angle of the display 15. In the example shown in the figures, the second end of the second connecting member 22 connected to the first connecting member 21 is provided with a hook portion 221 which is arc-shaped and hooked to a mounting handle (not shown in the figure) of the first connecting member 21, so that the second connecting member 22 can pivot around the mounting handle of the first connecting member 21.

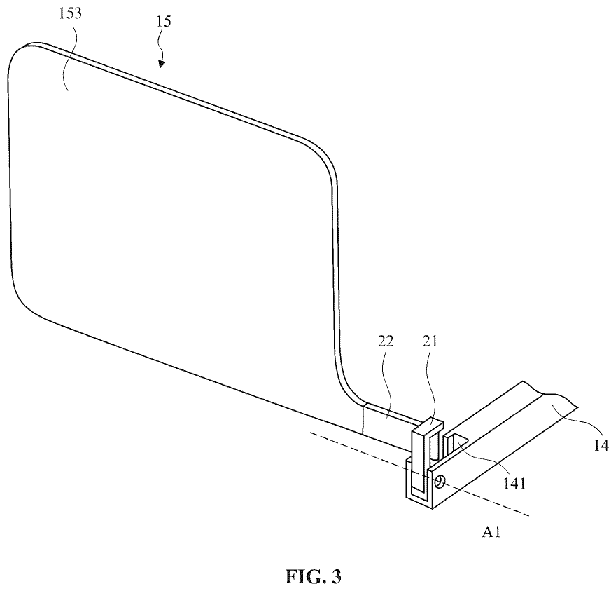

When the display 15 is displaced to the display standby position shown in FIG. 1 as the seat plate 13 is expanded, the display screen 151 of the display 15 faces the flight attendant U. At this time, the first connecting member 21 is partially located outside the recess 141 of the support rod 14, and the hook portion 221 of the second connecting member 22 is located outside the recess 141 of the support rod 14, as shown in FIG. 2. At this time, if the current pitch angle of the display screen 151 of the display 15 is not particularly suitable for the flight attendant U, the flight attendant U can exert force on the display 15, so that the display 15 is pivoted relative to the support rod 14 about the pivot axis A1 via the second connecting member 22 and the first connecting member 21. For example, the display 15 can be pivoted towards the flight attendant U to the position shown in FIG. 3. In the position shown in FIG. 3, the display 15 is pivoted to be substantially perpendicular to the support rod 14. In addition, the flight attendant U can also adjust the roll angle of the display 15 by applying force to the display 15 to pivot the display 15 relative to the first connecting member 21 around the pivot axis A2 via the second connecting member 22.

After the use of the display is finished, the flight attendant U can place the display 15 in the position shown in FIG. 2, stand up directly and leave the seat plate 13 of the aircraft seat 10 without additional operation to the display 15 or the support rod 14. As the seat plate 13 retracts to the seat plate stowed position, the display 15 and the support rod 14 pivot towards the bulkhead W1, so that the display 15 is displaced to the display stowed position. Since the angle between the support rod 14 and the seat plate 13 is less than 180 degrees, the display 15 located at the first end of the support rod 14 first approaches the bulkhead W1 or the headrest 11 during the pivoting of the support rod 14 following the seat plate 13. Due to the damped connection between the seat plate 13 and the backrest 12, the pivoting of the seat plate 13 is damped, avoiding a large impact between the display 15 and the bulkhead W1 or the headrest 11. Preferably, a frame 152 and/or the housing of the display screen 151 of the display 15 is made of flexible materials, so that during the pivoting of the display 15 following the seat plate 13, when the display 15 comes into contact with the bulkhead W1 or the headrest 11, the impact and wear on the display screen 151 are reduced. Or, when the flight attendant U is about to stand up, the flight attendant U can push the support rod 14 to a position where the angle between the support rod 14 and the seat plate 13 is about 180 degrees, so that the display 15 is prevented from first contacting with the bulkhead W1 or the headrest 11, in the process that the display 15 is displaced following the pivoting of the seat plate 13.

As the seat plate 13 further pivots to the seat plate stowed position, the contact of the display 15 with the bulkhead W1 or headrest 11 causes the display 15 and the support rod 14 to pivot relative to the seat plate 13 to be generally in line with the seat plate 13, and the display 15 is displaced to the display stowed position above the headrest 11. At this time, the display screen 151 of the display 15 faces the bulkhead W1. Preferably, an additional display D can be provided at a suitable position of the bulkhead W1 (for example, a position above the headrest 11), so that when the flight attendant U is standing, even if the display screen 151 of the display 15 faces the bulkhead W1 and is not visible, the flight attendant U can still observe the situation in the passenger cabin through this additional display D.

Further, when the flight attendant U is about to stand up, the flight attendant U can pivot the display 15 around the pivot axis A1 relative to the support rod 14 to the position shown in FIG. 4 through the second connecting member 22 and the first connecting member 21, and further pivot it until the first connecting member 21 is finally received in the recess 141 of the support rod 14, as shown in FIG. 5. Then, when the flight attendant U is standing and leaves the seat plate 13, as the seat plate 13 retracts to the seat plate stowed position, the support rod 14 pivots toward the bulkhead W1, so that the display 15 is displaced to the display stowed position above the headrest 11. At this time, a rear side 153 of the display 15 faces the bulkhead W1, and the display screen 151 faces outward, so that the flight attendant U can still observe the situation in the passenger cabin through the display screen 151 when standing.

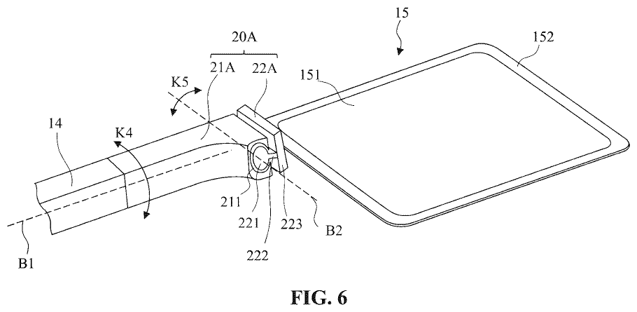

The connecting device between the display 15 and the support rod 14 is not limited to the form of the connecting device 20 shown in FIGS. 2 to 5. FIG. 6 shows a modified example of the connecting device between the display 15 and the support rod 14.

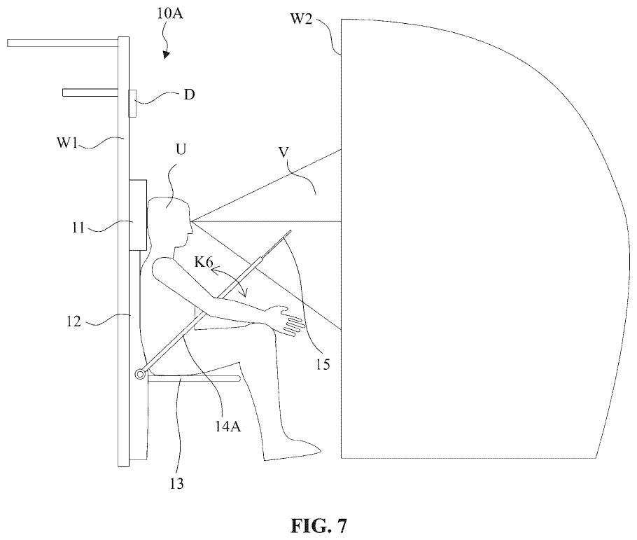

As shown in FIG. 6, the connecting device 20A between the display 15 and the support rod 14 includes a first connecting member 21A and a second connecting member 22A. A first end of the first connecting member 21A is pivotably mounted to a first end of the support rod 14, so that the first connecting member 21A is pivotable relative to the support rod 14 about a pivot axis B1 parallel to the support rod 14, as indicated by the double-headed arrow K4 in FIG. 7, to adjust a roll angle of the display 15. An opposite second end of the first connecting member 21A is provided with a recessed mounting portion 211. The second connecting member 22A is provided with a protruding mounting portion 221. The protruding mounting portion 221 is mounted to the recessed mounting portion 211 of the first connecting member 21A, and is pivotable in the recessed mounting portion 211 relative to the first connecting member 21A about a pivot axis B2 transverse to the support rod 14, as indicated by the double-headed arrow K5 in FIG. 6, to adjust a pitch angle of the display 15. In the example shown in the figure, the recessed mounting portion 211 is an open recessed portion with a C-shaped cross-section, and the protruding mounting portion 221 is correspondingly a column portion with a C-shaped cross-section. The second connecting member 22A is further provided with a connecting plate 222 and a mounting plate 223, where the protruding mounting portion 221 is connected to the mounting plate 223 via the connecting plate 222. The protruding mounting portion 221, the connecting plate 222 and the mounting plate 223 may be integrally formed. The display 15 is fixedly mounted on the mounting plate 223 of the second connecting member 22A. During installation, the protruding mounting portion 221 of the second connecting member 22A is aligned with the recessed mounting portion 211 of the first connecting member 21A, and the connecting plate 222 of the second connecting member 22A is aligned with the opening of the recessed mounting portion 211 of the first connecting member 21A, so that the second connecting member 22A is mounted to the first connecting member by sliding along the direction of the pivot axis B2. In the figure, in order to show the structures of the first connecting member 21A and the second connecting member 22A, an end cap at an end portion of the recessed mounting portion 211 is not shown. The display 15 is pivotably mounted to the support rod 14 by the mounting of the second connecting member 22A with the first connecting member 21A and the mounting of the first connecting member 21A with the support rod 14, so that the display 15 is pivotable relative to the support rod 14 in the direction shown by the double-headed arrow K4 or the direction shown by the double-headed arrow K5, thereby adjusting the orientation of the display 15.

The aircraft seat 10 according to the first embodiment of the present disclosure has been described above. In the aircraft seat 10 according to the first embodiment of the present disclosure, the display 15 provided therein can facilitate the flight attendant to observe the state of the passengers in the passenger cabin during the flight of the aircraft, and the display 15 can be displaced following the pivoting of the seat plate 13 and automatically move to the display standby position or the display stowed position as the seat plate 13 is expanded or stowed, without additional actions by the flight attendant. Therefore, the flight attendant can observe the situation in the passenger cabin through the display 15 when sitting on the aircraft seat 10, and the flight attendant does not need to stand up or walk around the passenger cabin to observe the situation in the passenger cabin, and further, there is no need to give up the use of a part of the available space for passenger seats in the passenger cabin to meet the view requirements of the flight attendant, thereby ensuring efficient use of space in the passenger cabin.

FIG. 7 shows an aircraft seat 10A according to a second embodiment of the present disclosure. The aircraft seat 10A has substantially the same configuration as the aircraft seat 10 according to the first embodiment of the present disclosure, and the aircraft seat 10A is also mounted with a display 15. The only difference lies in the mounting position of the support rod 14A of the aircraft seat 10A for mounting the display 15. Hereinafter, only the difference between the aircraft seat 10A and the aircraft seat 10 will be described, and the same parts of the aircraft seat 10A and the aircraft seat 10 will be denoted by the same reference numerals and the description thereof will not be repeated.

As shown in FIG. 7, in the aircraft seat 10A, the second end of the support rod 14A is mounted to a pivot shaft at a rear end portion of the seat plate 13 so as to be pivotable together with the seat plate 13. As the seat plate 13 is pivoted to the seat plate expanded position, the support rod 14A can be pivoted to the position shown in FIG. 7 so that the display 15 is in the display standby position; and when the flight attendant U leaves the seat plate 13, the support rod 14A pivots toward the bulkhead W1 as the seat plate 13 pivots to the seat plate stowed position, so as to displace the display to the display stowed position above the headrest 11. Preferably, the support rod 14A is such mounted that it can also pivot relative to the seat plate 13, so that the flight attendant U can also pivot the support rod 14A relative to the seat plate 13 by applying force to the support rod 14A as required, as indicated by the double-headed arrow K6 in FIG. 7, so as to adjust the display 15 at the first end of the support rod 14A to a suitable position within the view field V of the flight attendant U.

The connection between the display 15 and the support rod 14A may adopt the connecting device 20 or the connecting device 20A in the aircraft seat 10 according to the first embodiment of the present disclosure, which will not be repeated here.

The aircraft seat 10A according to the second embodiment of the present disclosure can achieve beneficial technical effects similar to those of the aircraft seat 10 according to the first embodiment.

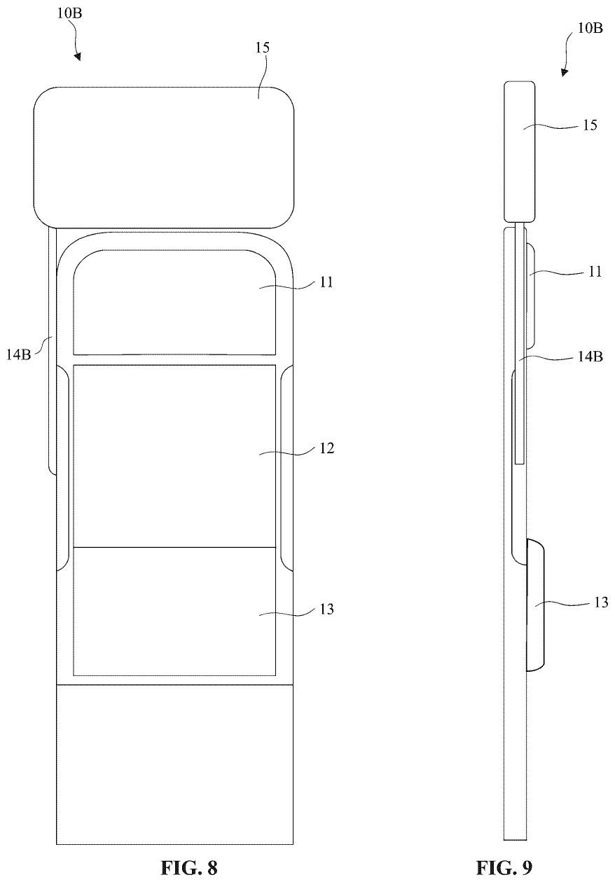

FIGS. 8 to 13 show schematic views of an aircraft seat 10B according to a third embodiment of the present disclosure. The aircraft seat 10B has substantially the same configuration as the aircraft seat 10 according to the first embodiment of the present disclosure, and the aircraft seat 10B is also mounted with a display 15. The only difference lies in the mounting position of the support rod 14B of the aircraft seat 10B for mounting the display 15.

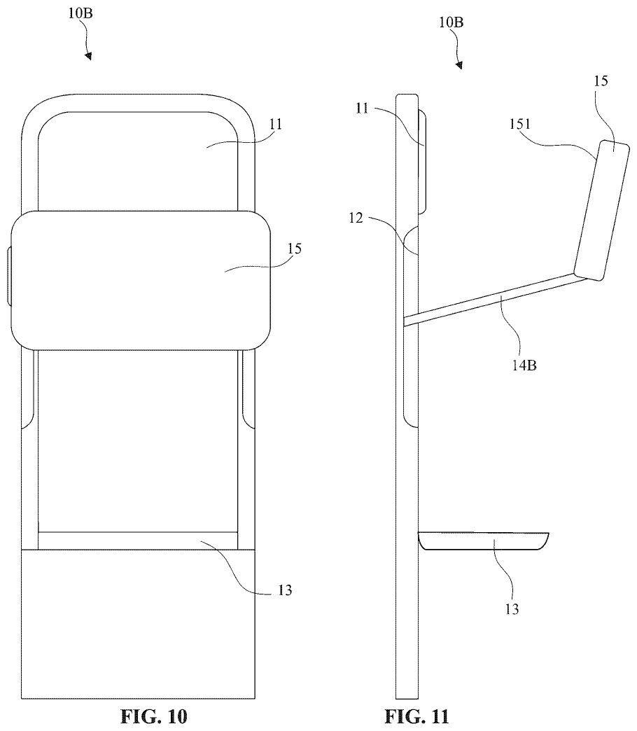

FIGS. 8 and 9 show a state in which the aircraft seat 10B is stowed, and FIGS. 10 and 11 show a state in which the aircraft seat 10B is expanded. FIGS. 8 and 10 are front views of the aircraft seat 10B, and FIGS. 9 and 11 are side views of the aircraft seat 10B.

The display 15 of the aircraft seat 10B is mounted to a side portion of the backrest 12 via the support rod 14B. The display 15 is mounted to a first end of the support rod 14B, and an opposite second end of the support rod 14B is pivotably mounted to the side portion of the backrest 12, and the support rod is arranged to pivot following the pivoting of the seat plate 13. As the seat plate 13 pivots from the seat plate stowed position shown in FIGS. 8 and 9 to the seat plate expanded position shown in FIGS. 10 and 11, the support rod 14B accordingly pivots to the position shown in FIGS. 10 and 11, so that the display 15 is in the display standby position.

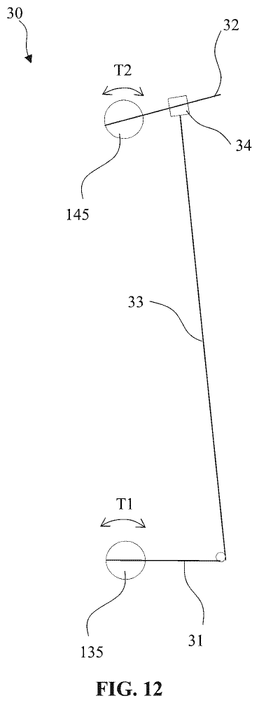

For this purpose, the aircraft seat 10B is further provided with a linkage mechanism 30 configured to correspondingly pivot the pivot shaft of the support rod 14B in accordance with the pivoting of the pivot shaft of the seat plate 13, so that the display 15 is correspondingly displaced. FIG. 12 shows a schematic view of the linkage mechanism 30. As shown in FIG. 12, the linkage mechanism 30 is configured as a link mechanism, including a first link 31, a second link 32 and a third link 33. The first link 31 is partially fixedly connected (for example, welded) to the pivot shaft 135 of the seat plate 13, preferably fixed to the pivot shaft 135 in a radial direction of the pivot shaft 135, such that a suspended end of the first link 31 is located outside the pivot shaft 135. The second link 32 is partially fixedly mounted (for example, welded) to the pivot shaft 145 of the support rod 14B, preferably fixed to the pivot shaft 145 in a radial direction of the pivot shaft 145, such that a suspended end of the second link 32 is located outside the pivot shaft 145. A sliding universal joint 34 is installed on the second link 32, and the sliding universal joint 34 is slidable along the second link 32 within a certain range. One end of the third link 33 is hinged to the suspended end of the first link 31, and the other end of the third link 33 is hinged to the sliding universal joint 34. When the pivot shaft 135 of the seat plate 13 pivots as indicated by the arrow T1 to pivot the seat plate 13, the pivoting of the pivot shaft 135 drives the first link 31 to pivot, and drives, through the third link 33 and the sliding universal joint 34, the second link 32 to pivot, and thereby drives the pivot shaft 145 of the support rod 14B to pivot as indicated by the arrow T2, so that pivoting of the seat plate 13 causes the support rod 14B to pivot in a linkage way. The linkage mechanism 30 may be received inside the backrest 12 and not visible from the outside, so as not to affect the appearance of the aircraft seat 10B.

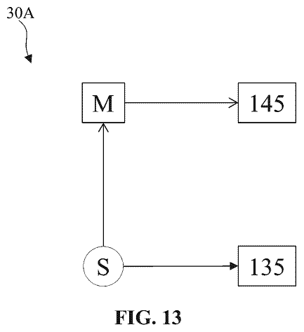

In the above example, the linkage mechanism 30 is designed as a mechanical linkage mechanism. However, the present disclosure is not limited to thereto. In other examples according to the present disclosure, the linkage mechanism 30 may also be designed as an electric mechanism, thereby making the whole structure more compact. FIG. 13 shows a linkage mechanism 30A according to a modified example. As shown in FIG. 13, the linkage mechanism 30A includes a sensor S and an electric motor M. The sensor S is configured to detect the pivoting of the pivot shaft 135 of the seat plate 13. The electric motor M drives the pivot shaft 145 of the support rod 14B to pivot accordingly according to the detection result of the sensor S.

The aircraft seat 10B according to the third embodiment of the present disclosure can achieve beneficial technical effects similar to those of the aircraft seat 10 according to the first embodiment and the aircraft seat 10A according to the second embodiment.

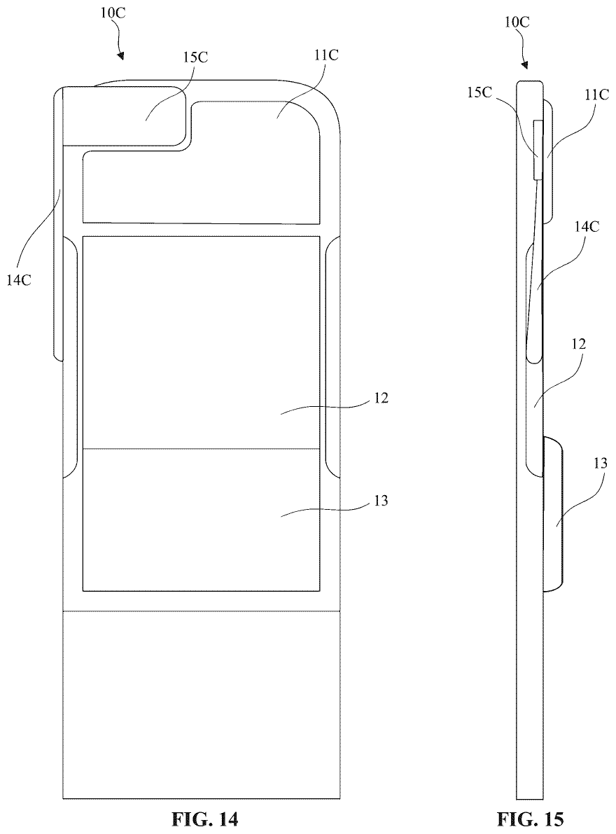

FIGS. 14 to 17 show schematic views of an aircraft seat 10C according to a fourth embodiment of the present disclosure. The aircraft seat 10C has substantially the same configuration as the aircraft seat 10B according to the third embodiment of the present disclosure. The only difference lies in the design of the display 15 of the aircraft seat 10C.

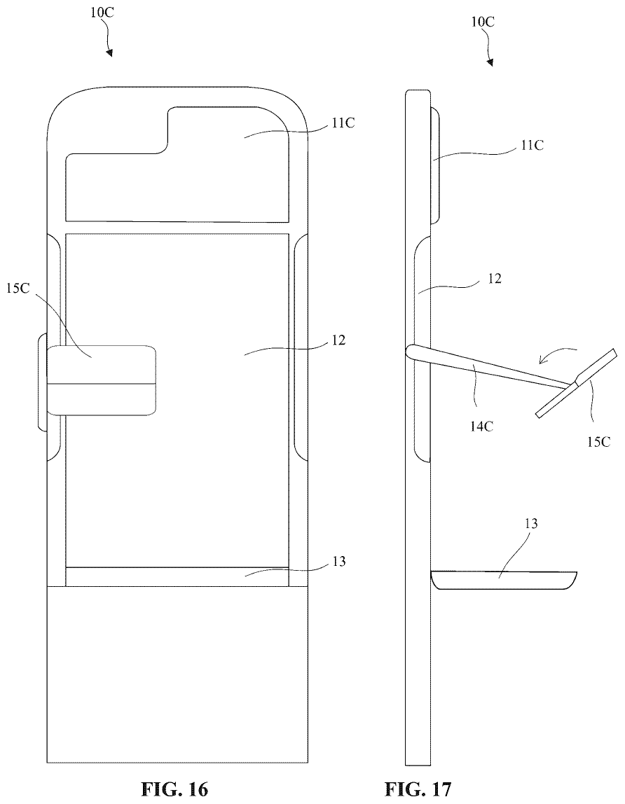

FIGS. 14 and 15 show a state in which the aircraft seat 10C is stowed, and FIGS. 16 and 17 show a state in which the aircraft seat 10C is expanded, where FIGS. 14 and 16 are front views of the aircraft seat 10C, and FIGS. 15 and 17 are side views of the aircraft seat 10C.

The display 15C of the aircraft seat 10C is mounted to a first end of the support rod 14C, and an opposite second end of the support rod 14C is pivotably mounted to the side portion of the backrest 12, and the support rod 14C is arranged to pivot following the pivoting of the seat plate 13. The linkage between the support rod 14C and the seat plate 13 is realized by the linkage mechanism 30 or the linkage mechanism 30A used in the aircraft seat 10B, the description of which will not be repeated here.

As shown in FIG. 14, the display stowed position of the display 15C is located in the headrest 11C, and a part of the headrest 11C is arranged to receive the display 15C. Preferably, the display 15C has a foldable display screen. In the display stowed position, the two parts of the display 15C are stacked against each other, making the entirety of the aircraft seat more compact. When the seat plate 13 pivots to the seat plate expanded position, the display 15C is displaced following the pivoting of the seat plate 13 to the display standby position in the view field in front of the flight attendant via the support rod 14C, and then, the flight attendant unfolds the two parts of the display 15C that are stacked against each other as indicated by the arrow shown in FIG. 17, thereby unfolding the display screen of the display 15C, as shown in FIGS. 16 and 17, for the flight attendant to use.

The aircraft seat 10C according to the fourth embodiment of the present disclosure can achieve beneficial technical effects similar to those of the aircraft seat 10B according to the third embodiment.

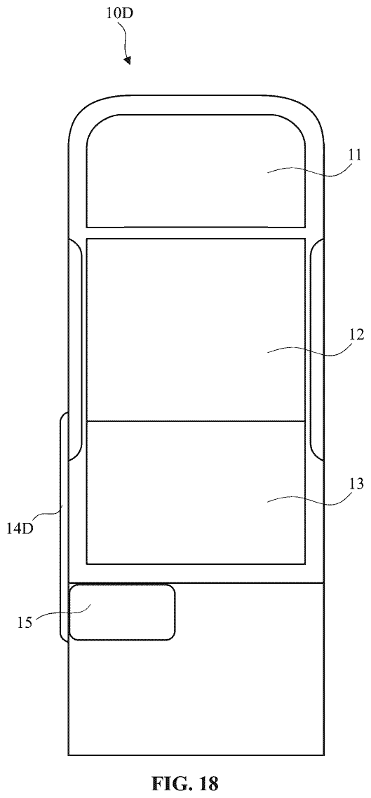

FIG. 18 show a schematic view of an aircraft seat 10D according to a fifth embodiment of the present disclosure, showing a state in which the aircraft seat 10D is stowed. The aircraft seat 10D has substantially the same configuration as the aircraft seat 10B according to the third embodiment of the present disclosure. The only difference lies in the display stowed position of the display 15 of the aircraft seat 10D. As shown in FIG. 18, the display stowed position of the display 15 is located below the seat plate 13.

The aircraft seat 10D according to the fifth embodiment of the present disclosure can achieve beneficial technical effects similar to those of the aircraft seat 10B according to the third embodiment.

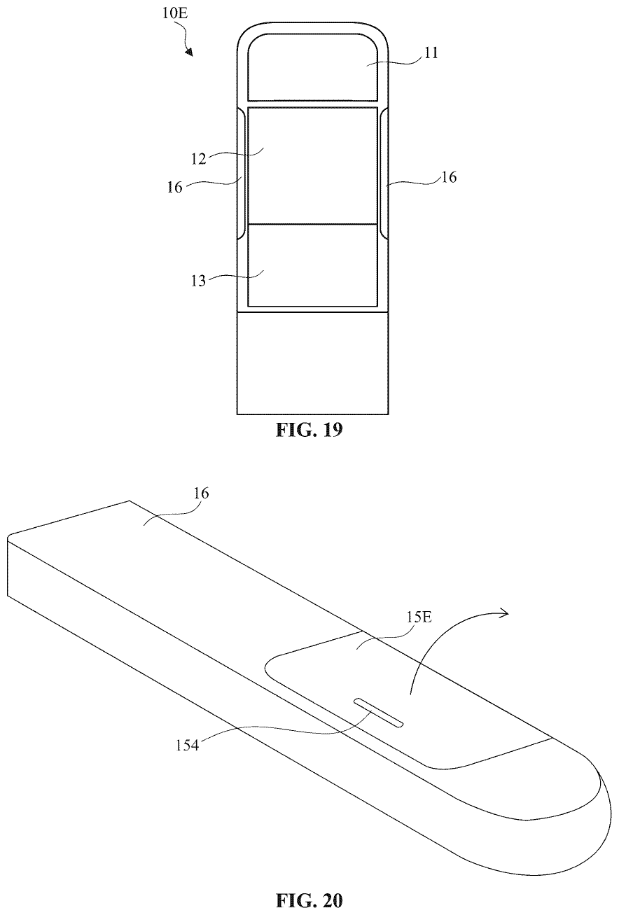

FIGS. 19 to 22 show schematic views of an aircraft seat 10E according to a sixth embodiment of the present disclosure. The aircraft seat 10E is different from the aircraft seat of the foregoing embodiments in that the aircraft seat 10E is provided with an armrest, and the display is supported and received by the armrest.

FIG. 19 shows a state in which the aircraft seat 10E is stowed. As shown in FIG. 19, the aircraft seat 10E includes a headrest 11, a backrest 12, a seat plate 13, and an armrest 16. One end of the armrest 16 is pivotably mounted to the side portion of the backrest 12, and is arranged to move in a linkage way with the seat plate 13. As the seat plate 13 pivots to the seat plate stowed position, the armrest 16 is stowed to two sides of the backrest 12, as shown in FIG. 19. Further, as the seat plate 13 pivots to the seat plate expanded position, the armrest 16 is expanded for use.

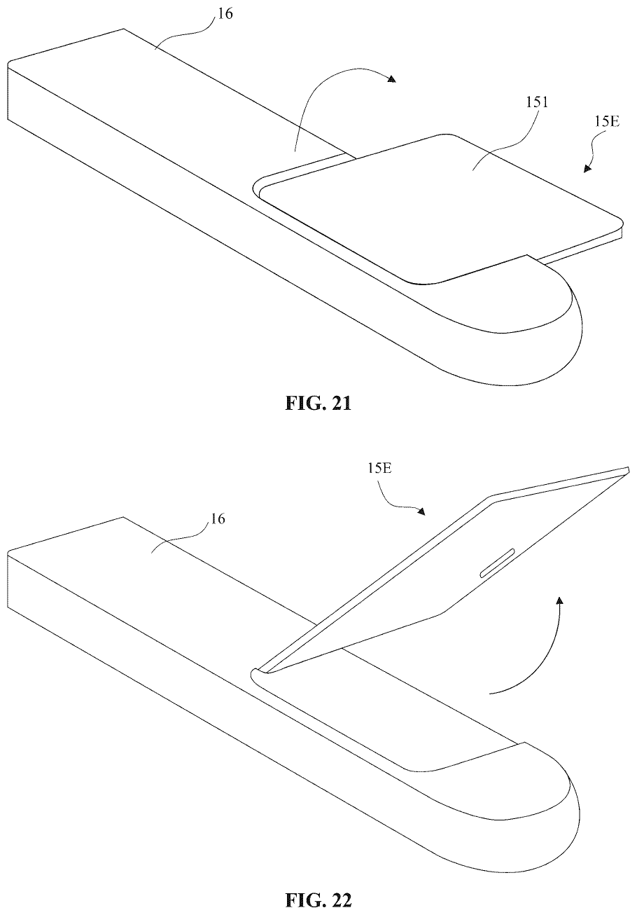

The aircraft seat 10E is provided with a display 15E, and the display 15E is in the form of a foldable display. FIG. 20 shows a perspective view of the armrest 16. As shown in FIG. 20, the display 15E is folded and received in the armrest 16, and a grip portion 154 is provided on a back housing of the display 15E for the flight attendant to grasp to expand the display 15E in the direction indicated by the arrow, so that the display screen 151 of the display 15E faces outward, as shown in FIG. 21. In the example shown in the figure, the grip portion 154 may be implemented as a recess that can accommodate the fingers of the flight attendant. After the display 15E is expanded to the state shown in FIG. 21, the display 15E can be pivoted upward to adjust the pitch angle to an appropriate angle, as shown in FIG. 22.

The aircraft seat 10E according to the sixth embodiment of the present disclosure can achieve beneficial technical effects similar to the aircraft seat according to the foregoing embodiments. In addition, the arrangement between the armrest 16 and the display 15E is not limited to the above-mentioned implementation, and various modifications can be made to the armrest and the display, as long as the display can be supported and received by the armrest.

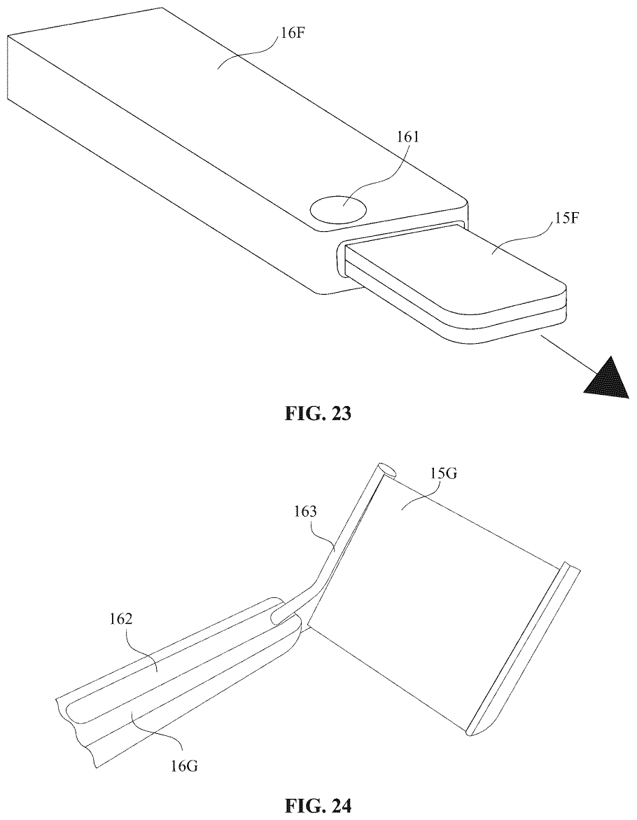

FIG. 23 shows a perspective view of an armrest 16F according to a modified example. As shown in FIG. 23, a front end portion of the armrest 16F is provided with a hollow cavity. The display 15F is in the form of a foldable display supported and received in the hollow cavity of the armrest 16F. The armrest 16F is further provided with a switch 161. After the armrest 16F is expanded from the backrest along with the expanding of the seat plate, the display 15F is ejected from the armrest 16F by pressing the switch 161, as indicated by the arrow in FIG. 23. Then, the parts of the display 15F that are stacked against each other are expanded, and the display screen of the display 15F is pivoted to a suitable angle for use.

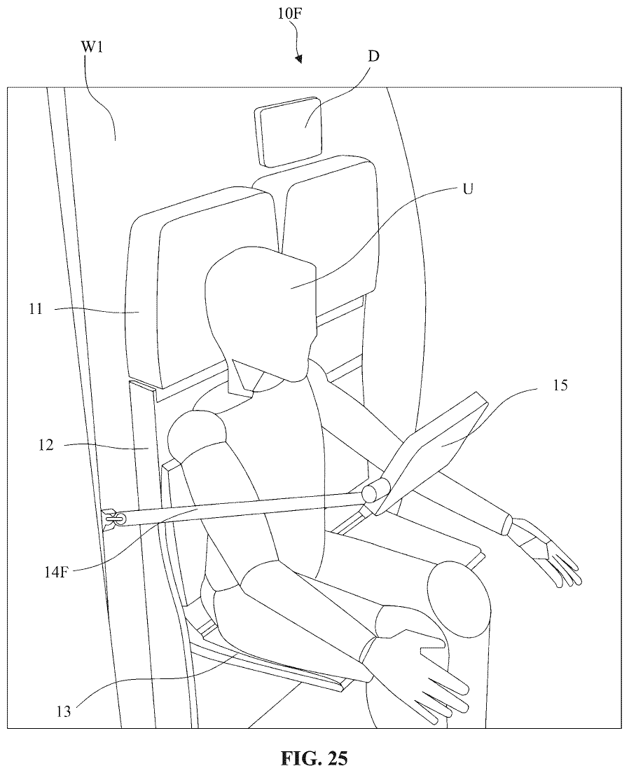

FIG. 24 shows a perspective view of an armrest 16G according to another modified example. As shown in FIG. 24, the armrest 16G is provided with a receiving recess 162 and a reel 163. The reel 163 is pivotably mounted to an end portion of the armrest 16G, and can be pivoted to be received in the receiving recess 162 of the armrest 16G, and can be pivoted to the outside from the receiving recess 162 of the armrest 16G. The display 15 includes a flexible display screen. The display 15 can be stowed by winding the display 15 on the reel 163 and pivoting the reel 163 to the receiving recess 162.

FIG. 25 shows a schematic view of an aircraft seat 10F according to a seventh embodiment of the present disclosure. The aircraft seat 10F has substantially the same configuration as the aircraft seat 10B according to the third embodiment of the present disclosure. The only difference lies in the installation position of the support rod for supporting the display of the aircraft seat 10F.

As shown in FIG. 25, the display 15 is mounted to a first end of the support rod 14F, and an opposite second end of the support rod 14F is pivotably mounted to the bulkhead W1 on which the aircraft seat 10F is mounted, and is mounted close to a side portion of the backrest 12 of the aircraft seat 10F. The support rod 14F is configured to correspondingly pivot following pivoting of the seat plate 13, thereby enabling the display 15 to be displaced correspondingly. The linkage between the support rod 14F and the seat plate 13 is realized by the linkage mechanism 30 or the linkage mechanism 30A used in the aircraft seat 10B according to the third embodiment of the present disclosure, the description of which will not be repeated here.

The aircraft seat 10F according to the seventh embodiment of the present disclosure can achieve beneficial technical effects similar to those of the aircraft seat according to the foregoing embodiments.

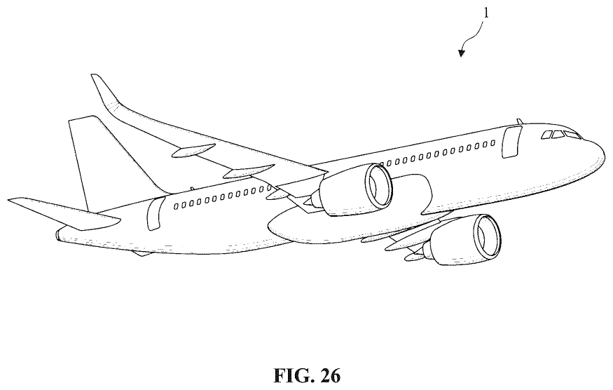

FIG. 26 shows a perspective view of an aircraft 1 installed with the aircraft seat according to the present disclosure. By means of the aircraft seat according to the present disclosure, the flight attendant can easily observe the situation in the passenger cabin of the aircraft 1 when sitting on the aircraft seat, and there is no need to give up the use of a part of the available space in the passenger cabin to meet the view requirements of the flight attendant, thereby ensuring efficient use of space in the passenger cabin of the aircraft 1.

The exemplary embodiments of the aircraft seat according to the present disclosure have been introduced above in conjunction with the application of the aircraft seat in a flight attendant seat in a passenger cabin of an aircraft. However, it should be noted that the aircraft seat according to the present disclosure is not limited to be mounted to a bulkhead within the passenger cabin of the aircraft to be used as a flight attendant seat. In other examples according to the present disclosure, the aircraft seat can be mounted to a bulkhead in proximity to the exits of an aircraft. For example, the bulkhead W1 to which the aircraft seat is mounted is a bulkhead in a cockpit of an aircraft, and preferably, the bulkhead W1 to which the aircraft seat is mounted is further mounted with an additional display that is located such as above the headrest of the aircraft seat.

The exemplary embodiments of the aircraft seat and the aircraft according to the present disclosure have been introduced in details as above. It should be understood that the present disclosure is not limited to the specific embodiments described and shown in detail above. Without departing from the spirit and scope of the present disclosure, those skilled in the art can make various modifications and variations to the present disclosure. All the variations and modifications shall fall within the scope of the present disclosure. Moreover, all the components described herein can be replaced by other technically equivalent components.

1. An aircraft seat comprising:
a headrest;
a backrest located below the headrest; and
a seat plate pivotably mounted to the backrest and configured to be pivotable relative to the backrest from a seat plate stowed position to a seat plate expanded position for seating by a user and to be automatically pivotable from the seat plate expanded position to the seat plate stowed position in response to the user's departure,
wherein the aircraft seat is further provided with a display which is configured to displace as the seat plate pivots, wherein when the seat plate is pivoted to the seat plate expanded position, the display is displaced to a display standby position, and as the seat plate pivots to the seat plate stowed position, the display is displaced to a display stowed position.

2. The aircraft seat according to claim 1, wherein the display is mounted to a first end of a support rod, and the support rod is configured to pivot following pivoting of the seat plate.

3. The aircraft seat according to claim 2, wherein the display is mounted to the support rod via a connecting device, wherein the connecting device comprises:
a first connecting member pivotably mounted to the first end of the support rod; and
a second connecting member, wherein the display is mounted to a first end of the second connecting member, and a second end of the second connecting member is pivotably mounted to the first connecting member,
wherein one of the first connecting member and the second connecting member is configured to pivot about a pivot axis transverse to the support rod to adjust a pitch angle of the display, and the other of the first connecting member and the second connecting member is configured to pivot about a pivot axis parallel to the support rod to adjust a roll angle of the display.

4. The aircraft seat according to claim 2, wherein a second end of the support rod is mounted to a front end portion of the seat plate or to a pivot shaft of the seat plate, and the support rod is configured to be pivotable relative to the seat plate.

5. The aircraft seat according to claim 2, wherein a second end of the support rod is pivotably mounted to a side portion of the backrest, or
a second end of the support rod is pivotably mounted to a bulkhead on which the aircraft seat is mounted, and is mounted close to a side portion of the backrest.

6. The aircraft seat according to claim 5, further comprising a linkage mechanism configured to correspondingly pivot a pivot shaft of the support rod in accordance with the pivoting of a pivot shaft of the seat plate.

7. The aircraft seat according to claim 6, wherein the linkage mechanism comprises:
a sensor configured to detect the pivoting of the pivot shaft of the seat plate; and
an electric motor configured to drive the pivot shaft of the support rod to pivot according to a detection result of the sensor.

8. The aircraft seat according to claim 2, wherein the display stowed position is one of the following positions: above the headrest; below the seat plate; or in the headrest.

9. The aircraft seat according to claim 1, further comprising an armrest, wherein the armrest is configured to pivot following pivoting of the seat plate, the display is supported by the armrest, and the display is configured to be folded or wound to be received in the armrest.

10. The aircraft seat according to claim 1, wherein a display screen of the display is a flexible display screen.

11. The aircraft seat according to claim 1, wherein the display is configured to receive and display footage of a cabin compartment of an aircraft.

12. An aircraft, comprising the aircraft seat according to claim 1.

13. The aircraft according to claim 12, wherein the aircraft seat is mounted to a bulkhead within the cabin compartment of the aircraft, and the bulkhead is further mounted with an additional display located above the headrest of the aircraft seat.

14. The aircraft according to claim 13, wherein the cabin compartment is a passenger compartment or a cockpit of the aircraft.

15. The aircraft seat according to claim 2, wherein the display is configured to receive and display footage of a cabin compartment of an aircraft.

16. The aircraft seat according to claim 3, wherein the display is configured to receive and display footage of a cabin compartment of an aircraft.

17. The aircraft seat according to claim 4, wherein the display is configured to receive and display footage of a cabin compartment of an aircraft.

18. The aircraft seat according to claim 5, wherein the display is configured to receive and display footage of a cabin compartment of an aircraft.

19. The aircraft seat according to claim 8, wherein the display is configured to receive and display footage of a cabin compartment of an aircraft.

20. The aircraft seat according to claim 9, wherein the display is configured to receive and display footage of a cabin compartment of an aircraft.
